(19) United States
(12) Patent Application Publication
(10) Pub. No.: US 2026/0065775 A1
(43) Pub. Date: Mar. 5, 2026

(54) PRECIPITATION DETECTION AND COMMUNICATION SYSTEM WITH CONNECTED VEHICLES

(71) Applicant: FCA US LLC, Auburn Hills, MI (US)

(72) Inventors: Lucas J. Romero, Auburn Hills, MI (US); Noah R. O'Bryan, Auburn Hills, MI (US)

(21) Appl. No.: 18/820,417

(22) Filed: Aug. 30, 2024

(51) Int. Cl. G08G 1/0967; B60S 1/04; G08B 21/18; G08G 1/09

(52) U.S. Cl. CPC G08G 1/0967; B60S 1/04; G08G 1/091; G08B 21/182

(57) ABSTRACT

A method for determining a precipitation event from network vehicles, includes receiving at a backend portion information relating to a precipitation event, associating the precipitation event with a location, comparing the information relating to the precipitation event to one or more thresholds, and sending a notification from the backend portion to multiple vehicles when one or more thresholds are met.

### FIELD

The present disclosure relates to systems and methods for determining and communication regarding one or more precipitation events.

### BACKGROUND

Precipitation can reduce the visibility of a driver of a vehicle and pose a hazard to safe vehicle operation. Weather forecasts and other weather information can be unreliable, and can be delayed and not time relevant. A need exists by which, among other things, a driver of a vehicle can receive information about precipitation conditions in an area relevant to the vehicle in real-time, and in advance of the vehicle entering the area in which the precipitation is occurring.

### SUMMARY

In at least some implementations, a method for determining a precipitation event from network vehicles, includes receiving at a backend portion information relating to a precipitation event, associating the precipitation event with a location, comparing the information relating to the precipitation event to one or more thresholds, and sending a notification from the backend portion to multiple vehicles when one or more thresholds are met.

In at least some implementations, a precipitation event is determined upon activation of a vehicle windshield wiper, wherein data indicative of the activation is included in the information.

In at least some implementations, a precipitation event is determined from data from a rain sensor, where the data is included in the information.

In at least some implementations, the method also includes rating a severity of the precipitation event based upon one or more event parameters, and comparing the rating to a rating threshold. In at least some implementations, the event parameters include information about one or a combination of one or more of vehicle dynamic parameters, vehicle type parameters, road conditions, environmental conditions, and windshield wiper activation parameters. In at least some implementations, the vehicle dynamic parameters include at least one vehicle speed at the time of the precipitation event. In at least some implementations, the windshield wiper activation parameters include a rate or a frequency of windshield wiper activation.

In at least some implementations, the method also includes receiving at the backend portion information about one or more environmental conditions.

In at least some implementations, the multiple vehicles to which the notification is sent are determined to be in a geographic area including the location or traveling toward the geographic area including the location.

In at least some implementations, the precipitation event is one of multiple precipitation events, and each of the multiple precipitation events is associated with a particular geographic area in which each of the multiple precipitation events occurred, and wherein the one or more thresholds includes a threshold for a number of precipitation events in each particular geographic area. In at least some implementations, each geographic area is rated with regard to a likelihood of a precipitation event occurring in a threshold time period from the current time. In at least some implementations, the rating for each geographic area is based at least in part on individual ratings for each of the multiple precipitation events.

In at least some implementations, a system of a network vehicle for detecting a precipitation event includes a windshield wiper, a position sensor arranged to provide information relating to the location of the network vehicle, a control system that includes a data storage unit and an electronic control unit, a communications unit that is communicated with the control system and that has a receiver by which information is received at a network vehicle and a transmitter by which information is transmitted from the network vehicle, and a backend portion of a cloud-based system. The backend portion is configured to receive from the communications unit information relating to a precipitation event and to transmit a notification including information relating to the precipitation event to one or more network vehicles.

In at least some implementations, the backend portion includes a processor with programming to analyze information received from the one or more network vehicles and determine occurrence of a precipitation event from at least part of the information. In at least some implementations, the at least part of the information includes data relating to activation of the windshield wiper. In at least some implementations, the at least part of the information includes data indicative of liquid being detected by a rain sensor of the network vehicle.

In at least some implementations, the backend portion is communicated with multiple network vehicles and receives and analyzes information relating to the precipitation event from the multiple network vehicles. In at least some implementations, the multiple network vehicles are within a geographic area of a predetermined size. In at least some implementations, the one or more thresholds includes a threshold for a number of network vehicles that transmit information relating to the precipitation event in the geographic area.

In at least some implementations, the control system provides information to the communications unit for transmission to the backend portion, and the information includes information relating to activation of the windshield wiper, information relating to one or more vehicle parameters and information relating to the vehicle location, and the backend portion includes programming arranged to analyze the information relating to the activation of the windshield wiper and determine a rating for an event at least in part based upon the analysis of the information relating to the activation of the windshield wiper.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a diagrammatic view of a system for detecting and determining precipitation events;

FIG. 2 is a diagrammatic view of a vehicle that defines part of the system;

FIG. 3 is a diagrammatic view of a vehicle control system which may define part of a frontend portion of the system; and

FIG. 4 is a flowchart of a method for determining driving conditions and providing notifications regarding loss of traction events.

### DETAILED DESCRIPTION

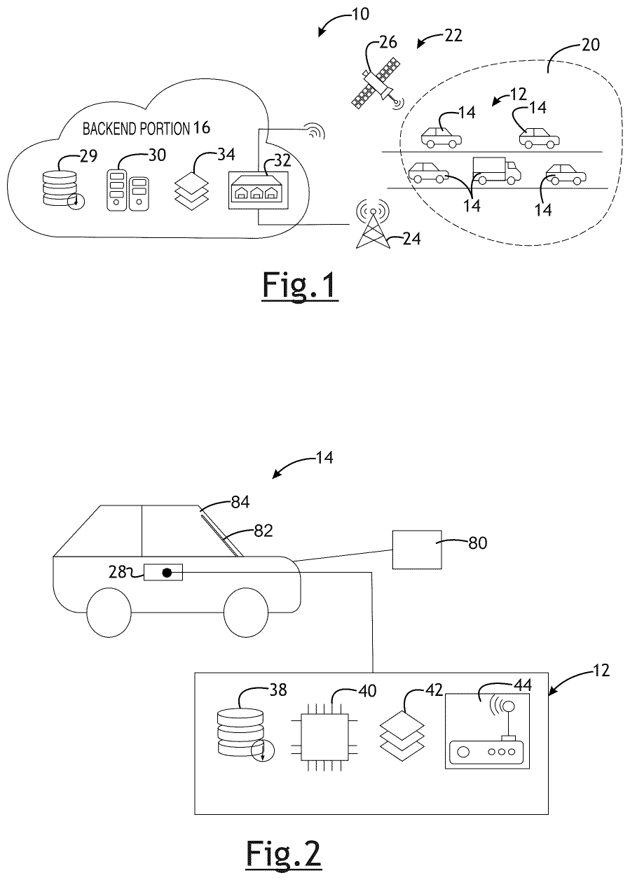

Referring in more detail to the drawings, FIG. 1 illustrates a vehicle information system 10 including a frontend portion 12 with one or more network vehicles 14 that are traveling along one or more roads and that are in communication with a backend portion 16. The network vehicles 14 are used to determine areas having one or more environmental conditions such as those of a nature or type that other vehicles can benefit from being alerted to the condition(s). For example, vehicles heading toward or into an area having conditions including precipitation like rain, snow or sleet, can benefit from advance notice of the presence of the condition(s) and the relative severity of the condition(s). Numerous network vehicles 14 may be spread across a geographic area 20 and enable determination of at least certain environmental conditions within the geographic area 20 without direct operator/driver involvement. That is, control systems 28 of network vehicles 14 can be operated in the background, and the output thereof analyzed, without driver or passenger involvement, to avoid distractions and enable automatic and efficient information gathering and communication.

The system 10 may include a cloud-based component to which vehicles communicate information relating to at least some conditions and from which such information may be provided to other vehicles. In this way, a distributed grouping or fleet of network vehicles 14 can each provide information about conditions of interest within different geographic areas 20 and multiple vehicles providing such information can improve the accuracy and scope of the information provided.

With reference to the schematic block diagrams in FIGS. 1 and 2, the vehicle information system 10 may be a cloud-based system that may receive information from individual ones of the network vehicles 14 and send out one or more notifications to multiple network vehicles 14 including information related to one or more conditions of interest. The notifications may be sent out to all network vehicles 14 or only the network vehicles 14 within a predetermined geographic area 20. The system 10 may gather real-time information from network vehicles 14, and the system 10 may analyze the information to determine if a notification should be sent to other vehicles, and if so, the area of interest and which network vehicles 14 are associated with the area of interest.

The term “real-time”, as used herein, does not strictly require that such information and notifications be generated, sent, received and/or otherwise processed at the exact moment when their underlying events or conditions occur in order to be “real-time”. Rather, these terms broadly include any such information and notifications that are generally contemporaneous with their underlying events or conditions so that the environmental conditions information and notifications are still relevant or accurate in the context of the present system and method (e.g., within seconds, minutes or even hours of their underlying events or conditions).

System 10 may deliver hosted services via the internet and/or other communication networks and may be structured as a public, private or hybrid cloud, for example. According to one non-limiting example, vehicle information system 10 is structured as a private cloud and generally includes the backend portion 16 and the frontend portion 12 that is distributed across a fleet of network vehicles 14, where each network vehicle 14 is capable of obtaining and providing information as well as communicating with the backend portion 16 over a secure communications network 22 (e.g., secure vehicle-to-cloud (V2C) network). The secure communications network 22 may include a cellular-based network 24, a satellite-based network 26, a city-wide WiFi-based network, some other type of communications network and/or a combination thereof. Although only a few network vehicles 14 are shown in the drawings, it should be appreciated that system 10 may interact with a large fleet of vehicles that can include dozens, hundreds, thousands or even more vehicles. System 10 may be used with any vehicles, including (but not limited to) passenger, commercial and/or public transportation vehicles sold in any geographic area.

Backend portion 16 may include any suitable combination of software and/or hardware resources typically found in a backend of a cloud-based system, as best illustrated in FIG. 1. The backend portion 16 may be responsible for managing some of the programs and algorithms that run applications on the frontend portion 12, such as those that request, obtain and optionally analyze information of and from the network vehicles 14. It is noted that the environmental conditions information may be analyzed by control systems 28 and processors on-board a network vehicle 14 or by the backend portion 16 or both, as desired. The backend portion 16 may be managed or controlled by the vehicle manufacturer and can be part of a larger cloud-based system that the vehicle manufacturer uses to communicate and interact with a large fleet of vehicles for a multitude of purposes, not just detection of environmental conditions and related alerts. The backend portion 16 may include or communicate with emergency alert systems, such as those that provide Amber alerts or other missing persons alerts, or law enforcement systems that may provide and receive information regarding vehicles of interest to them.

The backend portion 16 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 16). In one example, the backend portion 16 has a number of backend resources including data storage systems 29, processors or servers 30, communication systems 32, programs and algorithms 34, as well as other suitable backend resources. It should be appreciated that backend portion 16 is not limited to any particular architecture, infrastructure or combination of elements, and that any suitable backend arrangement may be employed.

Frontend portion 12 may include any suitable combination of software and/or hardware resources typically found in a frontend of a cloud-based system, as shown in FIG. 2, and is generally responsible for sending information to the backend portion and receiving notifications and the like from the backend portion 16. Depending on the particular arrangement, the frontend portion 12 may also be responsible for gathering camera, sensor, location and/or other data from devices on the vehicle 14 and sending such information to the backend portion 16. The frontend portion 12 is typically responsible for running the applications that interface with the users in the different vehicles 14, and for interfacing with the programs and algorithms 34 of the backend portion 16. The frontend portion 12 may also be managed or controlled by the vehicle manufacturer and can be part of a larger cloud-based system that the vehicle manufacturer uses to communicate and interact with a large fleet of vehicles for various purposes, as mentioned above. The frontend portion 12 may be distributed across one or more vehicles 14 and may include any suitable combination of software and/or hardware resources including, but not limited to, components, devices, computers, modules and/or systems (each of these resources is referred to herein as a “frontend resource,” which broadly includes any such resource located at the frontend portion 12).

In one example, the frontend portion 12 has a number of frontend resources including a vehicle control system 28 having one or more vehicle electronic module(s) installed in vehicles 14, which may include some combination of a data storage unit 38, an electronic control unit 40, applications 42, a communications unit 44 (e.g., one that includes a telematics unit and/or other communication devices with a receiver by which information is received at unit 44 and a transmitter by which information is sent from the unit 44), as well as other suitable frontend resources. The control system 28 may be or include a telematics control module (TCM), a body control module (BCM), an infotainment control module, or any other suitable module known in the art. It is not necessary for the preceding units to be packaged in a single vehicle electronic module, as illustrated in FIG. 2; rather, they could be distributed among multiple vehicle electronic modules, they could be stand-alone units, they could be combined or integrated with other units or devices, or they could be provided according to some other configuration. It should be appreciated that frontend portion 12 is not limited to any particular architecture, infrastructure or combination of elements, and that any suitable frontend arrangement may be employed.

The systems and methods may be made to identify the existence of one or more conditions for which notifications are to be made to vehicles within one or more geographic areas. Such a condition may be, for example, an environmental condition that reduces visibility and/or vehicle tire traction on a road, such as rain, snow, ice/sleet, and wet, snowy or icy roads. Such conditions can be difficult for a driver or driving system to determine until a vehicle is already affected by the condition.

To control various functions of the vehicle 14, the vehicle control system 28, among other things, monitors and provides controls for operation of various vehicle systems. For example, the vehicle 14 may include drive by wire, brake by wire and steer by wire systems, or the drive, brake and steering systems may be mechanically linked, as desired, and the control system 28 may be programmed or include instructions to respond to driver action, such as movement of the throttle, and brake and steering inputs. The magnitude of the power output from the powertrain system and brake system varies as a function of the driver operation of the throttle and brake inputs, as well as the instructions executed by the control system 28, which may vary in different circumstances and may be implemented in view of variables and by way of look-up tables, maps, algorithms and the like. Further, these systems may be operated partially or fully-autonomously, as desired.

To enable control and monitoring of various vehicle operating, environmental and other conditions related to vehicle operation, the control system 28 may include or be communicated with a range of sensors. By way of some examples, the vehicle 14 may include: a speed sensor 60 that provides an indication of vehicle speed; one or more accelerometers 62 responsive to vehicle accelerations in various directions and orientations; wheel speed sensors 64 responsive to the rotational speed of the vehicle wheels; drive input sensors (separate sensors, collectively referred to as 66) that sense the position and/or rate of movement of the throttle, brake and/or steering inputs, position or location sensors 68 or devices (such as GPS or the like) to determine the location of the vehicle; temperature sensors 70 for various things like ambient temperature, engine/motor temperature, and the like; rain sensor 72, a switch or sensor 74 responsive to windshield wiper actuation; and various other sensors 76 that may be responsive to or useful in controlling vehicle operation (e.g. current draw of motors, torque sensors, fuel level sensors, battery charge sensors, steering sensors).

In order to perform the functions and desired processing set forth herein, as well as the computations therefore, the control system 28 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing, as generally described with regard to the frontend portion 12. For example, the control system 28 may include input signal processing and filtering to enable accurate sampling and conversion or acquisitions of such signals from communications interfaces and sensors. As used herein the terms control system 28 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 28 may be distributed among different vehicle modules, such as an infotainment control module, engine control module or unit, powertrain control module, transmission control module, and the like, if desired, and the memory and one or more processors may be one or both integrated into the vehicle 14 or remotely located and wirelessly communicated to the vehicle 14, as desired.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

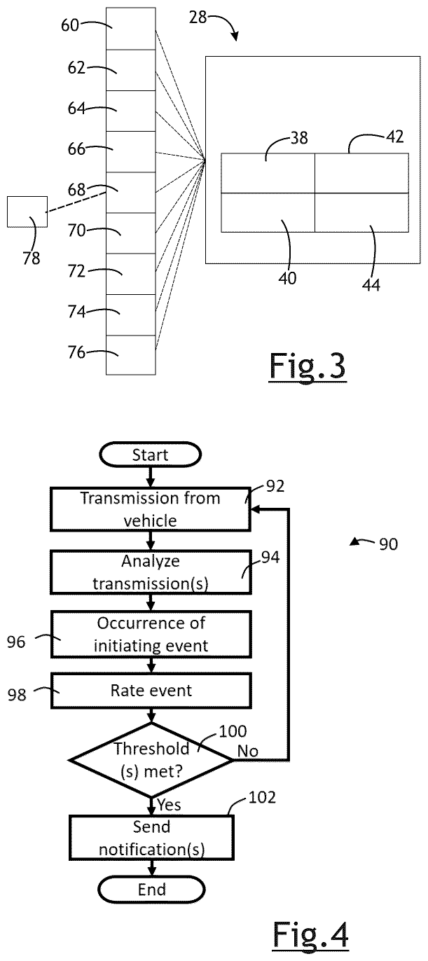

Various navigation programs 78 (FIG. 3) are known that compute a travel path to a destination, and convey information about the travel path to a driver in the form of visual and/or audible instructions for navigating the vehicle 14 along the travel path. The navigation programs can use information from the location sensor 68 (e.g. GPS) and map data and information relating to road conditions, speed limits, location of intersections and traffic signals, and the level of traffic (such as is available from Waze, GoogleMaps and other applications and sources). This information can be used to define travel paths that are shortest in total distance or time, or that avoid certain road types (e.g. not paved, toll roads, etc) or areas where travel time is less certain, for example, construction zones. The navigation programs 78 may be integrated into the vehicle control system 28 or infotainment system (which may be considered part of the control system), and/or can be resident on a mobile device that is connected to the vehicle 14 by wired or wireless connection.

Navigation programs may use data from numerous tracked vehicles currently traveling along, or that previously traveled along, roads within the travel path to provide crowd-sourced instantaneous and historical information about timing/duration of traffic patterns, average vehicle speeds by road, portions of roads, time of day, day of week, time of year, and the like. From this bulk information provided from many vehicles, the navigation programs can compare different route options that may be used in the travel path, and an estimated total time of travel can be provided, usually in the form of an estimated time of arrival at the chosen destination that is based on travel times and parameters along the entire travel path.

The travel path may include different types of roads, like city roads, rural roads, highways or other higher speed roads, that have different road conditions like speed limits, construction zones, intersections and stopping points which may be defined by traffic signs or traffic lights, for example. In addition to road conditions, the roads may have traffic levels that vary over time and may reduce travel speed as well as the number of stopping, braking and acceleration events when traveling on a road at a given time.

The frontend portion 12 or backend portion 16 or control systems 28 and/or a remote device may include one or more programs arranged to provide a weather source 80 (FIG. 2) for weather information. By way of non-limiting examples, the frontend portion 12, or a remote device associated therewith, may download or obtain weather information from one or more remote sources 80, like a weather service or weather database. The weather information may include data relating to presence of, a prediction of, or a rate/intensity of snowfall, rainfall, visibility, and other weather conditions such as wind speeds above a wind threshold (50 mph for example), hail, tornado and dense fog.

While one or more weather sources 80 may be used to provide general data about weather, environment conditions may also be determined, at least in part, from one or more vehicle sensors or vehicle data output. Additionally, some vehicles have rain sensors 72 (FIG. 3) that may be used to control windshield wipers 82 (FIG. 1) or headlights. The use of windshield wipers 82 could also be detected and provided from the remote vehicle 14 in a data transmission from the vehicle 14. Information received at the backend portion 16 that multiple vehicles in a certain geographic area 20 have activated windshield wipers 82 can be used to determine that there is precipitation in that area. Information that a single vehicle 14 has activated windshield wipers 82 could simply mean that a windshield washing system (e.g. including a dispenser for washer fluid and the wipers 82) is being utilized and the windshield wipers 82 were activated to clear off washer fluid from the windshield 84 (FIG. 1). This may also be determined, for example, by a short duration of activation, a short duration of activation that is not followed within a threshold time period by further activation of the wipers 82, and by activation of wipers 82 by one or more vehicles 14 in an area in which other vehicles 14 do not have activated wipers 82 (where more than one vehicle 14 in an area may utilize the windshield washing system at or near the same time, for example, vehicles 14 on a dusty/dirty road might use their washing system more frequently).

In at least some implementations, environmental conditions are monitored with respect to actuation of one or both of rain sensors 72 and windshield wipers 82 (e.g. as determined from sensor 74 or otherwise) as connected vehicles 14 move within one or more geographic areas 20. For example, positive detection of liquid by a rain sensor 72 or actuation of a windshield wiper 82 can be a condition that causes a data/information transmission from the vehicle 14/front end portion 12 (via communications unit 44) to the backend portion 16 and may be logged by the backend portion 16 with regard to one or more event parameters. In at least some implementations, data transmissions may be made when the windshield wipers 82 are activated (i.e. turned on), when the wipers 82 are deactivated (i.e. turned off), and when the activation parameters have changed. A change in activation parameters may be, for example, a change in the intermittent frequency and/or speed of wiper movement.

In at least some implementations, the vehicles 14 may transmit data during operation, at certain intervals or in a stream that may occur continuously during vehicle operation and not just upon occurrence of an initiating event that causes the control system 28 to initiate a transmission. Thus, the vehicles 14/control systems 28 can be programmed to transmit data in the ordinary course of vehicle use and regarding numerous vehicle operating parameters. The data can be captured or logged by the backend portion 16 and some analysis conducted. When the status of different vehicle features or systems changes (e.g. on/off or activated/deactivated or activated and adjusted), the data provided from the vehicle 14 may include the numerous vehicle operating parameters and also data indicative of the feature or system status change. The backend portion 16 may then determine occurrence of the feature or system status change and execute methods or programs in accordance with predetermined programs or instructions. The data may be transmitted in any desired format, and for efficiency of computational resources, may be provided in a binary code stream from the vehicle 14 to the backend portion 16, and the backend portion 16 may include programming to decipher/interpret the binary code.

Example event parameters that may be communicated from the vehicles 14 and logged in the backend portion 16 include the rate at which the windshield wipers 82 are activated (e.g. slow, medium, fast, intermittent or continuous), whether the rain sensor 72 continually detects liquid or just intermittently, vehicle type parameters, like the weight and performance characteristics of the vehicle 14 (acceleration, braking, steering, suspension type), vehicle dynamic parameters at the time of the event like wheel speed, vehicle speed, accelerations, and the like, road conditions like type of road, and environmental conditions like time of day and weather conditions at time of event, and the like. The event parameters can be rated, for example on a numerical scale having at one end a rating for conditions that lead to maximum driving or visibility impairment and at the other end a rating for conditions that lead to a minimum or greatly reduced driving or visibility impairment.

In at least some implementations, the relative rating may be made at least in part as a function of a determined severity of precipitation or visibility impairment. The severity may be determined as a function of the windshield wiper actuation characteristics, like the speed and frequency of wiper movement, and vehicle speed, for example. A vehicle 14 traveling at higher speed may use the windshield wipers 82 at a higher level (speed and/or frequency) for a certain severity of rainfall than if the vehicle 14 were traveling at a slower speed. The data from each vehicle 14 may be rated and compared against data (or the lack thereof) from other vehicles 14 in a certain area (e.g. a geofenced region of a predetermined or threshold size), from vehicles 14 within a certain geofenced area of each other may be jointly rated, or the like.

In at least some implementations, different types of event parameters can be given individual ratings to make up a total event parameter rating, or the rating can be determined otherwise as desired. For example, the type of road on which the vehicle 14 is traveling (e.g. paved vs. unpaved) can be rated separately from the windshield wiper actuation characteristics which may be unrelated to the type of road. Knowing the type of road may be useful in communicating to other drivers, as will be noted later.

Further, the number of events that occur within a certain area 20 can be used to determine the boundaries of the condition causing the events to occur. The severity of the event, such as rainfall, causing the data transmissions may vary within a larger area experiencing the event. In this way, the severity rating may vary for one or more smaller regions within a larger area. The boundary of an area 20 in which events are determined to be occurring can be defined by analysis of the locations of the vehicles 14 providing the data transmissions to the backend portion 16. The event parameters transmitted from the vehicles 14 includes the location of the vehicle 14 and such events are associated with one or more geographic areas 20, and they may be rated or categorized as noted herein, to, among other things, facilitate a determination as to how relevant the event is to other vehicles 14 in the same geographic area 20 or determined to be heading to or toward that area.

The events may be logged based upon time of occurrence to aid in determining if there is a present or past condition causing the determined precipitation or decrease in visibility or increased driving impairment. Thresholds may be set for the number of events within a given time period, and this may be based upon the number of vehicles 14 in an area. For example, if, after a threshold number of events have occurred in a given geographic area during a threshold time period, an alert or notification may be issued to provide notice to other drivers and vehicles 14 about the area in which data transmissions are occurring, as set forth later. If, after such determination, a high enough number of vehicles 14 travel, without data transmission relating to an event, through a geographic area 20 in which there previously were at least a threshold number of events/data transmissions, then the alert can be terminated, in at least some implementations. In this way, the determinations of risk or higher than threshold rates precipitation can be made time sensitive to avoid providing notifications when the conditions that caused the notification are no longer are determined to exist.

When one or more conditions are met, the backend portion 16 may communicate information to one or more vehicles 14 for which the information is determined to be relevant. The information may include, by way of non-limiting examples, an alert about the area of precipitation and the severity of precipitation. Based on a vehicles direction of travel and the area of precipitation, the information may include a projected time when the vehicle 14 is expected to encounter the precipitation and may provide a suggested vehicle speed in the area of precipitation that may be less than a speed limit of a road on which the vehicle 14 is traveling and which may vary as a function of the determined severity of precipitation. The speed may be provided as a certain number, a range, or by general recommendation such as to slow down or reduce speed.

The notice can be provided to the vehicle 14 for presentation to or review by a vehicle occupant in any desired way. The notice can be provided on a vehicle display, such as in a pop-up window including text, graphic(s), animation(s), etc., in an audio file played by the vehicle infotainment system, or provided to a remote device that is paired or otherwise connected to the vehicle control system 28 for audible or visual presentation, or by some combination of these non-limiting examples.

This can enable notices to be provided about higher risk conditions in defined geographic areas, such as an isolated area experiencing a heavy downpour of rain. These incidents can be quickly identified by the system and notifications can be provided to drivers heading to these areas. This can be done automatically, without requiring human/driver actions to transmit data to the backend portion 16.

Further, the notices can be limited to vehicles 14 in the area, or heading in the direction of a road segment or area of higher risk, or likely to head in that direction, so vehicles 14 outside of the area and not likely to head into that area need not receive the notification. This can reduce the number of notifications that drivers receive that are not relevant to the driver. Receipt of numerous notices that end up not being relevant can be frustrating, and can cause drivers to turn off the notification system or to lose confidence in the accuracy of the system and thereafter ignore or pay less attention to notifications they receive.

FIG. 4 illustrates a method 90 incorporating certain features of this disclosure. The method may begin at step 92 in which information is communicated from the vehicle 14 to the backend portion 16. The information may include any desired parameters (wiper activation parameters/settings, rain sensor data, vehicle data, vehicle instantaneous operation data, time, location, etc.) and may be sent within a predetermined time period of the initiating event occurring or having been determined to occur. The information may be transmitted in any desired form, such as but not limited to the transmissions disclosed in U.S. patent application Ser. No. 18/820,398, filed on Aug. 30, 2024 and incorporated herein by reference in its entirety.

Next, in step 94, the transmitted information is logged and analyzed at the backend portion 16, and may be associated with regard to the time and location at which they occurred. The method may proceed to step 96 in which an initiating event is determined to occur from the information transmitted in step 92 and by analysis of the information in step 94. The initiating event is a predetermined event such as activation of the vehicle windshield wipers 82. When the initiating event occurs, the method proceeds to step 98 in which the events may be rated with regard to severity of one or more event parameters, with regard to information from vehicles 14 in the same geographic area, or otherwise as set forth herein. By way of one non-limiting example, a greater amount or percentage of vehicles 14 in a geographic area that have activated windshield wipers 82 increases the confidence in a determination that precipitation is present, and may result in a rating of higher severity or likelihood of precipitation. The opposite may also be true (e.g. fewer vehicles 14 with wipers 82 activated may decrease the confidence and lead to a corresponding, lower risk rating). Similarly, multiple vehicles 14 with wipers 82 activated at a higher setting (e.g. higher speed, continual wiper use) increases the confidence that precipitation is falling at a higher rate and may result in a rating of higher severity or likelihood of precipitation. And again, the opposite may be true (fewer vehicles 14 with wipers 82 at higher settings may decrease the confidence and lead to a corresponding, lower severity or risk rating).

Confidence in the determination of and the rating of a precipitation event can be increased if information from the weather source also indicates precipitation in the relevant area, or decreased if the weather source does not indicate precipitation in the relevant area. In at least some implementations, no weather source is needed, or information from the weather source is not used in the determination of a precipitation event or the rating of an event.

In step 100, it is determined if one or more event parameter thresholds have been met for a geographic area. The thresholds may relate to, for example, the number of events within a geographic region or conditions otherwise determined to meet a threshold at which a sufficiently high risk or high likelihood for precipitation is determined. In at least some implementations, the ratings of individual vehicle events may be used to provide a rating for the associated geographic area, and the rating for a geographic area may be compared to one or more predetermined thresholds. If in step 100 the thresholds are not met, then the method may loop back to a desired point, for example, step 92 and wait for determination of the occurrence of another initiating event (e.g. turning on the wipers 82, turning off the wipers 82, changing a setting for the wiper activation).

If one or more event related thresholds are met, then in step 102 an alert or notification is sent. The alert or notification may be sent, automatically, without requiring human intervention, generation or broadcasting, from the backend portion 16 to one or more vehicles 14 for which such alert or notification is determined to be relevant. In at least some implementations, vehicles 14 currently in the geographic area, or the portion thereof, that is determined to have the above threshold condition(s) can be sent the alert or notification. Additionally, if desired, vehicles 14 heading toward that geographic area can be sent the alert or notification. The heading of the vehicles 14 can be determined based upon information provided from the vehicles 14 regarding their location, which might include the vehicles'directions of travel and speeds, and/or which might include information about an intended path of travel that may be input into a navigation system or program and communicated to the backend portion 16. The notification may be sent for a period of time in which the event related thresholds are met or exceeded, and so additional vehicles 14 may receive notifications over time as they near or enter the geographic area for which a notification is sent. The methods and systems may continually or periodically redetermine the event rating or other parameters and determine if notifications should continue to be sent to relevant vehicles 14, or if the notifications are no longer needed.

In at least some implementations, the alerts or notifications can be provided to vehicles 14 based on the speed of the vehicle 14 within a particular geographic area. For example, when precipitation of a certain rating is determined to occur, alerts or notifications can be issued to vehicles 14 in a relevant area that are also traveling at a speed greater than a threshold, where the threshold varies as a function of the severity of the determined event rating. In this way, in at least some implementations, vehicles 14 that are traveling more slowly in a given area need not be given the alert or notification while vehicles 14 traveling faster can be provided the notification. Selective alerts or notifications may be particularly useful where the area of interest/with precipitation occurring exists on a portion of a road where vehicles 14 commonly change speed or otherwise interact with other vehicles 14 and wherein reduced visibility can be an increased hazard. The parameters for when a vehicle 14 receives the alert or notification, or whether a vehicle 14 receives the alerts or notifications at all, can be selectable by users, if desired. This may be done, for example, by selection of menu options in an application provided via the infotainment system or a remote device, like a smartphone, tablet or computer.

The systems and methods described herein enable automatic detection of environmental conditions of interest, such as precipitation, and automatic determination of when and to which vehicles 14 notifications or alerts should be provided. The systems and methods use networked vehicles 14 that automatically provide to a backend portion 16 of the system, information relating to various parameters from which determinations of precipitation can be made (e.g. from rain sensor 72 or windshield wiper data). In at least some implementations, the systems and methods relate to connected, cloud-based precipitation detection and analysis that leverages vehicle signal data and pattern analysis to determine or infer the potential severity of precipitation and driving conditions. Windshield wiper state and activation parameters are monitored onboard the vehicle 14 and changes are sent from the vehicle/front end portion to the cloud/backend portion 16. Changes in activation parameters can be evaluated and sent to the cloud when set conditions are met. This allows the exclusion of outliers such as mist and use of the windshield cleaning system. The output of this analysis can be used to map inclement weather conditions and warn nearby drivers. This could be combined with vehicle speed to provide safe driving recommendations.

The notifications may be provided automatically as determined by the system such that human determination and broadcasting is not required. The notifications can be provided to only a subset of vehicles 14 in a geographic area, such as those within or heading toward the specific geographic areas having conditions that caused the notification to be sent. Vehicles 14 not associated with the specific areas need not receive the notifications and so vehicles 14 receive fewer notifications that are not relevant to them, and user confidence in the notifications and the systems is increased.

1. A method for determining a precipitation event from network vehicles, comprising:
receiving at a backend portion information relating to a precipitation event;
associating the precipitation event with a location;
comparing the information relating to the precipitation event to one or more thresholds; and
sending a notification from the backend portion to multiple vehicles when one or more thresholds are met, wherein the precipitation event is one of multiple precipitation events, and each of the multiple precipitation events is associated with a particular geographic area in which each of the multiple precipitation events occurred, and wherein the one or more thresholds includes a threshold for a number of precipitation events in each particular geographic area, and wherein each geographic area is rated with regard to a likelihood of a precipitation event occurring in a future time period within a threshold time period from the current time.

2. The method of claim 1 wherein a precipitation event is determined upon activation of a vehicle windshield wiper, wherein data indicative of the activation is included in the information.

3. The method of claim 1 wherein a precipitation event is determined from data from a rain sensor, where the data is included in the information.

4. The method of claim 1 which also includes rating a severity of the precipitation event based upon one or more event parameters, and comparing the rating to a rating threshold.

5. The method of claim 4 wherein the event parameters include information about one or a combination of one or more of vehicle dynamic parameters, vehicle type parameters, road conditions, environmental conditions, and windshield wiper activation parameters.

6. The method of claim 5 wherein the vehicle dynamic parameters include at least one vehicle speed at the time of the precipitation event.

7. The method of claim 5 wherein the windshield wiper activation parameters include a rate or a frequency of windshield wiper activation.

8. The method of claim 1 which also includes receiving at the backend portion information about one or more environmental conditions.

9. The method of claim 1 wherein the multiple vehicles to which the notification is sent are determined to be in a geographic area including the location or traveling toward the geographic area including the location.

10. (canceled)

11. (canceled)

12. The method of claim 1 wherein the rating for each geographic area is based at least in part on individual ratings for each of the multiple precipitation events.

13. A system of a network vehicle for detecting a precipitation event, comprising:
a windshield wiper;
a position sensor arranged to provide information relating to the location of the network vehicle;
a control system that includes a data storage unit and an electronic control unit;
a communications unit that is communicated with the control system and that has a receiver by which information is received at a network vehicle and a transmitter by which information is transmitted from the network vehicle; and
a backend portion of a cloud-based system, wherein the backend portion is configured to receive from the communications unit information relating to a precipitation event and to transmit a notification including information relating to the precipitation event to one or more network vehicles, wherein the precipitation event is one of multiple precipitation events, and each of the multiple precipitation events is associated with a particular geographic area in which each of the multiple precipitation events occurred, and wherein the one or more thresholds includes a threshold for a number of precipitation events in each particular geographic area, and wherein each geographic area is rated with regard to a likelihood of a precipitation event occurring in a future time period within a threshold time period from the current time.

14. The system of claim 13 wherein the backend portion includes a processor with programming to analyze information received from the one or more network vehicles and determine occurrence of a precipitation event from at least part of the information.

15. The system of claim 14 wherein the at least part of the information includes data relating to activation of the windshield wiper.

16. The system of claim 14 wherein the at least part of the information includes data indicative of liquid being detected by a rain sensor of the network vehicle.

17. The system of claim 13 wherein the backend portion is communicated with multiple network vehicles and receives and analyzes information relating to the precipitation event from the multiple network vehicles.

18. The system of claim 17 wherein the multiple network vehicles are within a geographic area of a predetermined size.

19. The system of claim 13 wherein the control system provides information to the communications unit for transmission to the backend portion, and the information includes information relating to activation of the windshield wiper, information relating to one or more vehicle parameters and information relating to the vehicle location, and the backend portion includes programming arranged to analyze the information relating to the activation of the windshield wiper and determine a rating for an event at least in part based upon the analysis of the information relating to the activation of the windshield wiper.
